(19) United States
(12) Patent Application Publication
(10) Pub. No.: US 2021/0357227 A1
(43) Pub. Date: Nov. 18, 2021

(54) RISC-V ISA BASED MICRO-CONTROLLER UNIT FOR LOW POWER IOT AND EDGE COMPUTING APPLICATIONS

(71) Applicant: ASA MICROSYSTEMS, INC., San Josse, CA (US)

(72) Inventors: Md. Ashraful ISLAM, Yokohama-shi (JP); Seiji MIWA, Tokyo (JP); Moazzem HOSSAIN, San Jose, CA (US)

(21) Appl. No.: 17/317,862

(22) Filed: May 11, 2021

Related U.S. Application Data
(60) Provisional application No. 63/023,586, filed on May 12, 2020.

(51) Int. Cl. G06F 9/30; G06F 9/38

(52) U.S. Cl. CPC G06F 9/30145; G06F 9/3804; G06F 9/3001; G06F 9/30043

(57) ABSTRACT

A micro-controller unit (MCU) for low power IoT and edge computing applications is disclosed. MCU includes instruction fetching module configured to fetch instruction from instruction memory, instruction decoding module configured to decode instruction to obtain decoded instruction, and execution module including first and second execution units and clock gating circuit. Second execution unit is configured to execute instruction types. Execution module is configured to receive instruction from instruction decoding module and execute decoded instruction via particular logic circuit from first logic circuits associated with first execution unit. First logic circuits except the particular logic circuit are turned-off during execution via clock gating circuit. Execution module is configured to determine whether type of decoded instruction is included in instruction types or not and disable second logic circuits included in second execution unit via clock gating circuit in response to determination that type of decoded instruction is not included in instruction types.

### TECHNICAL FIELD

The present disclosure relates to the field of micro-architecture of a micro controller unit (MCU) and, more particularly to, RISC-V instruction set architecture based MCU for low power Internet of Things (IoT) and edge computing applications.

### BACKGROUND

Generally, MCUs are incorporated in the processors of various electronic devices. The processors of the electronic devices may be capable of performing various operations based on the instructions executed by one or more MCUs in the processor. One of the main technology that needs high speed and real-time operations performed at various nodes (e.g., devices) is the Internet of Things (IoT). IoT is an emerging technology that refers to a pervasive presence of interconnected and uniquely identifiable physical devices, including an expansive variety of devices, protocols, domains, and applications. Due to the IoT's expected growth and potential impact, there has been considerable research on the IoTs communication and software layer. However, the challenges of IoT computing, especially with respect to device microprocessors, have not been studied with equal proportion. The IoT devices' microprocessors must satisfy increasingly growing computational and memory demands, maintain connectivity, and adhere to stringent design and operational constraints, such as low cost, and low power (energy) budgets. These factors introduce new substantial challenges in computing on these devices.

Currently, increasing consumer demands for high-performance IoT applications is resulting in the acquisition and transmission of complex data. Transmitting this data will result in bandwidth bottlenecks and may pose additional challenges for real-time scenarios where the latency must adhere to stringent deadline constraints The IoT can also incur significant and potentially unsustainable energy overheads. It has been observed that energy consumed while transmitting data is significantly more than the energy consumed while performing computations on the data.

In light of the above discussion, there is a need for a micro architecture of an MCU that is compliant with RISC-V-based instruction set architecture for low power IoT and edge computing applications.

### SUMMARY

Various embodiments of the present disclosure provide methods and systems for implementing RISC-V ISA based MCU for low power IoT and edge computing applications.

In one embodiment, a micro-controller unit (MCU) is disclosed. The MCU includes an instruction fetching module configured to fetch an instruction from an instruction memory. The MCU includes an instruction decoding module configured to decode the instruction to obtain decoded instruction. The MCU includes an execution module including a first execution unit, second execution unit, and a clock gating circuit. The second execution unit is configured to execute a plurality of instruction types. The execution module of the MCU is configured to receive the decoded instruction for executing, from the instruction decoding module. The execution module of the MCU is configured to execute the decoded instruction via a particular logic circuit from a plurality of first logic circuits associated with the first execution unit. The plurality of first logic circuits except the particular logic circuit is turned off during the execution via the clock gating circuit. The execution module of the MCU is configured to determine whether a type of the decoded instruction is included in the plurality of instruction types or not. In response to a determination that the type of the decoded instruction is not included in the plurality of instruction types, the execution module of the MCU is configured to disable a plurality of second logic circuits included in the second execution unit via the clock gating circuit.

In another embodiment, a computer-implemented method is disclosed. The computer-implemented method includes fetching, by an instruction fetching (IF) module of a micro-controller unit (MCU), an instruction from an instruction memory, and decoding, by an instruction decoding (ID) module of the MCU, the instruction to obtain decoded instruction. The computer-implemented method includes receiving, by an execution module of the MCU, the decoded instruction for executing from the instruction decoding module. The execution module includes a first execution unit, a second execution unit and a clock gating circuit, and the second execution unit is configured to execute a plurality of instruction types. The computer-implemented method includes executing, by the first execution unit, the decoded instruction via a particular logic circuit from a plurality of first logic circuits associated with the first execution unit. The plurality of first logic circuits except the particular logic circuit is turned off during the execution via the clock gating circuit. The computer-implemented method further includes determining, by the execution module, whether a type of the decoded instruction is included in the plurality of instruction types or not. The computer-implemented method furthermore includes disabling, by the execution module, a plurality of second logic circuits included in the second execution unit via the clock gating circuit in response to determining that the type of the decoded instruction is not included in the plurality of instruction types.

In yet another embodiment, a micro-controller unit (MCU) with variable pipeline structure compliance with RISC-V based architecture is disclosed. The MCU is configured to fetch an instruction from an instruction memory, decode the instruction to obtain decoded instruction, and facilitate execution of the decoded instruction via a particular logic circuit from a plurality of first logic circuits included in a first execution unit. The plurality of first logic circuits except the particular logic circuit is turned off during the execution via a clock gating circuit. The MCU is further configured to determine whether a type of the instruction is included in a plurality of instruction types or not. The plurality of instruction types is executed by a second execution unit. In response to a determination that the type of the decoded instruction is not included in the plurality of instruction types, the MCU is further configured to disable a plurality of second logic circuits included in the second execution unit via the clock gating circuit. In response to a determination that the type of the decoded instruction is included in the plurality of instruction types, the MCU is further configured to execute the decoded instruction via a specific logic circuit from a plurality of second logic circuits associated with the second execution unit. The plurality of second logic circuits except the specific logic circuit from the plurality of second logic circuits and the first execution unit are turned off during the execution via the clock gating circuit.

### BRIEF DESCRIPTION OF THE FIGURES

For a more complete understanding of example embodiments of the present technology, reference is now made to the following descriptions taken in connection with the accompanying drawings in which:

FIG. 1 is a schematic structural diagram of a typical five staged RISC-V processor, in accordance with an embodiment of the present disclosure;

FIG. 2 is a simplified block diagram of a computer system representing hardware components and connectivity, with an embodiment of the present disclosure;

FIG. 3 is a schematic structural diagram of an MCU, in accordance with an embodiment of the present disclosure;

FIG. 4 is a flow chart for an instruction execution flow of variable stage pipeline architecture, in accordance with an example embodiment of the present disclosure;

FIG. 5 is a schematic graphical representation of RISC-V instruction sets, in accordance with an embodiment of the present disclosure;

FIG. 6 is a schematic structural diagram of an MCU with static random-access memory (SRAM) based register file (RF), in accordance with an embodiment of the present disclosure;

FIG. 7 is a flow chart 700 for a process flow (i.e., a computer-implemented method) for metering power consumptions of an MCU, in accordance with an embodiment of the present disclosure;

FIGS. 8A and 8B, collectively, represent block diagram representations of an interface bus of the MCU with RISC-V architecture, in accordance with an embodiment of the present disclosure; and

FIG. 9 is a timing diagram representing the read and write transaction on an interface bus, in accordance with an embodiment of the present disclosure.

The drawings referred to in this description are not to be understood as being drawn to scale except if specifically noted, and such drawings are only exemplary in nature.

### DETAILED DESCRIPTION

In the following description, for purposes of explanation, numerous specific details are set forth in order to provide a thorough understanding of the present disclosure. It will be apparent, however, to one skilled in the art that the present disclosure can be practiced without these specific details. In other instances, systems and methods are shown in block diagram form only in order to avoid obscuring the present disclosure.

Reference in this specification to “one embodiment” or “an embodiment” means that a particular feature, structure, or characteristic described in connection with the embodiment is included in at least one embodiment of the present disclosure. The appearance of the phrase “in one embodiment” in various places in the specification is not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not for other embodiments.

Moreover, although the following description contains many specifics for the purposes of illustration, anyone skilled in the art will appreciate that many variations and/or alterations to said details are within the scope of the present disclosure. Similarly, although many of the features of the present disclosure are described in terms of each other, or in conjunction with each other, one skilled in the art will appreciate that many of these features can be provided independently of other features. Accordingly, this description of the present disclosure is set forth without any loss of generality to, and without imposing limitations upon, the present disclosure.

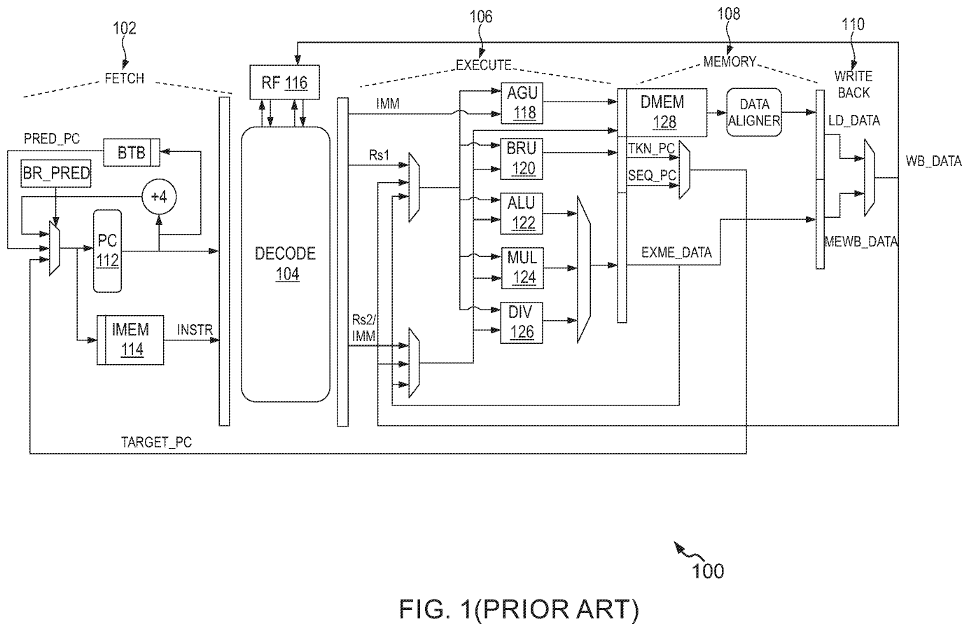

Various example embodiments of the present disclosure are described hereinafter with reference to FIGS. 1 to 9.

Referring now to FIG. 1, a conventional five-staged RISC-V processor 100 is described. The RISC-V processor 100 includes an instruction fetch (IF) stage (see, Fetch 102), an instruction decode (ID) stage (see, Decode 104), an instruction execution (EX) stage (see, Execute 106), a memory access (MA) stage (see, memory 108), and a write back (WB) stage (see, write back 110).

The architecture of the RISC-V processor 100 applies RISC-V instruction set architecture (ISA). The RISC-V ISA is an open source instruction set designed by Berkeley Architecture Group. In general, the RISC-V ISA is defined as a basic integer instruction set and other extended instruction sets. The basic 32-bit integer instruction set is defined as RV32I. Other typical extended instruction sets are defined as M for integer multiplication and division instructions, F for single-precision floating-point ones, D for double-precision floating-point ones, and A for atomic ones. In addition to these, a 32-bit general-purpose instruction set is defined as RV32G as the set of RV32I, M, A, F, and D. This is an instruction set architecture for general-purpose computing systems of broad range. RV64G is a 64-bit version of a general-purpose instruction set.

The RISC-V processor 100 includes circuit components to perform a plurality of operations in various pipeline stage architecture. The circuit components may include a program counter (see, PC 112), an instruction memory (see, IMEM 114), a register file (see, RF 116), an address generation unit (see, AGU 118), a branch unit (see, BRU 120), an arithmetic and logic unit (see, ALU 122), a multiplier (see, MUL 124), a divider (see, DIV 126), and a data memory (see, DMEM 128).

The instruction fetch stage (see, Fetch 102) in the RISC-V processor 100 includes the program counter (see, PC 112). The program counter 112 is configured to determine an address of a to-be-fetched instruction.

The instruction memory (see, IMEM 114) is configured to store the instructions to be performed by the RISC-V processor 100.

The instruction fetch (IF) stage (see, Fetch 102) is configured to read an instruction from the instruction memory (see, IMEM 114) indexed by the program counter (see, PC 112). It calculates the next value of PC 112 for instruction fetched from a target PC if a jump or a branch instruction is taken in execution stage. Alternatively, the IF stage calculates the next value of the PC 112 from a branch target buffer (BTB) if the branch is predicted to be taken. Otherwise, the sequential PC will increment the current value of PC 112 by 4. The IF stage 102 also delivers the instruction from the IMEM 114 to the ID stage (see, Decode 104).

The IF stage 102 delivers the instructions fetched from the IMEM 114 to the ID stage (decode 104). The ID stage (decode 104) is configured to decode the instructions and generate the necessary control signals. The necessary control signals may be used to determine the function of AGU 118, BRU 120, ALU 122 (e.g., addition or subtraction etc.), MUL 124, and/or DIV 126. The ID stage (decode 104) may also decode the register operand address for register file (RF) 116 and immediate value fields. The ID stage 104 may then read source operands from the RF 116.

The execution stage (see, execute 116) performs arithmetic, logical, multiplication, division operations based on the decoded instruction from the ID stage including operands and control signals. It also performs the jump or branch instructions target address. If the branch predicted during fetch 102 is found to be a wrong prediction, then the execution stage flushes the ID stage (see, Decode 104) and sets the PC 112 during the IF stage. The memory access stage (see, memory 108) is configured to load or store (referred as Load Store Unit LSU) the value from/to data memory (see, DMEM 128) depending on the instruction. Typically, load instructions move data from memory (see, DMEM 128) to the register. Store instructions move data from registers to memory (see, DMEM 128). Further, the write back stage (see, write back 110) is configured to write back the results of the execution stage and the memory stage to the RF 116.

A technical problem associated with the conventional RISC-V architecture is that the execution stage performs computational functions, as well as memory read/write operations, that lead to fixed pipeline stage architecture for all type of instructions and results in high power consumption.

Hence, to address these challenges and to provide other benefits, embodiments of the present disclosure provide RISC-V processor for low power IoT and edge computing applications with variable pipeline stage architecture. The technical objective of the variable pipeline architecture is to break down the instruction sets into two (or may be into more groups) such that one group will contain most frequently used instructions and whose functional units are smaller in size for implementation, and rest of the instructions are assigned in other group of execution stage. Now the execution stage will be subdivided into two (or more) stages. This results the variable pipeline execution and different functional units of this execution stages will be clock gated based on the instruction execution.

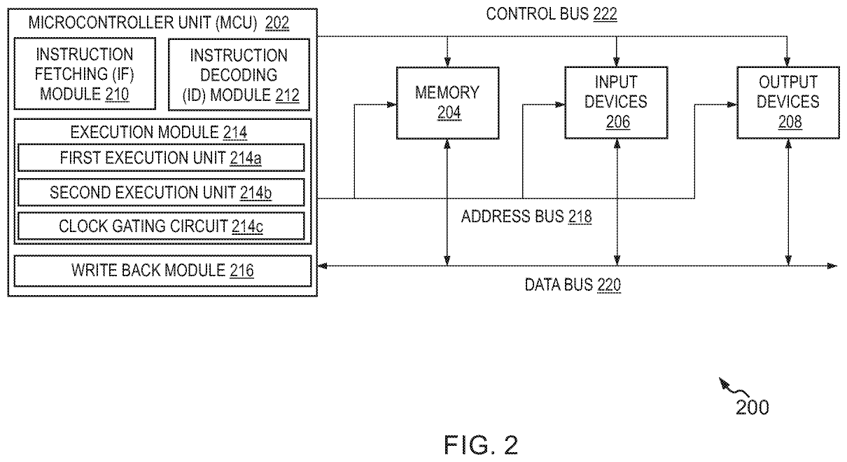

FIG. 2 is a simplified block diagram of a computer system 200 representing hardware components and connectivity, in accordance with an embodiment of the present disclosure. The computer system 200 may be an example of one of a smartphone, desktop, laptop, and the like. In one embodiment, the computer system 200 may be an edge computing device (for example, sensor nodes) in IoT system. In other words, the computer system 200 may relate to micro architecture of RISC-V instruction set architecture (ISA) for low power IoT and edge computing applications.

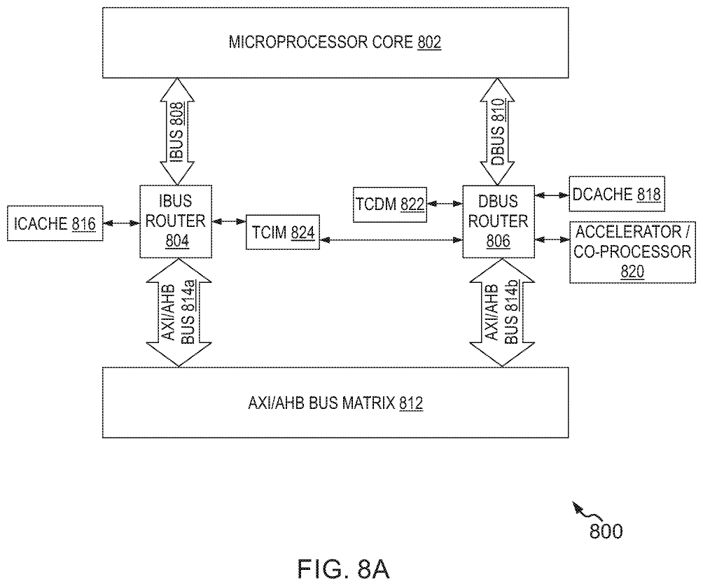

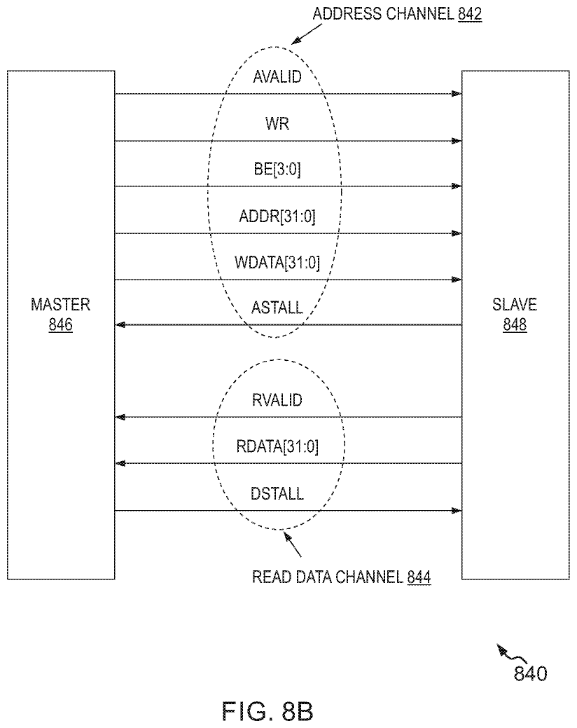

Each of these electronic devices may have the setup shown in FIG. 2 for typical working processes. The computer system 200 may generally include components such as a micro-controller unit (MCU) 202, memory 204, input devices 206, and output devices 208. Each of the components in the computer system may be connected with various buses such as an address bus 218, data bus 220, and a control bus 222. The address bus 218, the data bus 220 and the control bus 222 are implemented based on an interface bus protocol as described in FIGS. 8A and 8B.

Examples of the MCU 202 include, but are not limited to, an application-specific integrated circuit (ASIC) processor, a reduced instruction set computing (RISC) processor, a complex instruction set computing (CISC) processor, a field-programmable gate array (FPGA), and the like. The memory 204 includes suitable logic, circuitry, and/or interfaces to store a set of computer-readable instructions for performing operations. Examples of the memory 204 include a random-access memory (RAM), a read-only memory (ROM), a removable storage drive, a hard disk drive (HDD), and the like. It will be apparent to a person skilled in the art that the scope of the disclosure is not limited to realizing the memory 204 in the computer system 200, as described herein. In some embodiments, the memory 204 may be realized in the form of a database server or a cloud storage working in conjunction with the computer system 200, without deviating from the scope of the present disclosure. In one embodiment, the MCU 202 may also represent one or more processor cores.

Processor cores may be implemented in different ways, for different purposes, and in different processors. For instance, implementations of such cores may include: 1) a general purpose in-order core intended for general-purpose computing; 2) a high performance general purpose out-of-order core intended for general-purpose computing; 3) a special purpose core intended primarily for graphics and/or scientific (throughput) computing. Implementations of different processors may include: 1) a central processing unit (CPU) including one or more general purpose in-order cores intended for general-purpose computing and/or one or more general purpose out-of-order cores intended for general-purpose computing; and 2) a coprocessor including one or more special purpose cores intended primarily for graphics and/or scientific (throughput). Such different processors lead to different computer system architectures, which may include: 1) the coprocessor on a separate chip from the CPU; 2) the coprocessor on a separate die in the same package as a CPU; 3) the coprocessor on the same die as a CPU (in which case, such a coprocessor is sometimes referred to as special purpose logic, such as integrated graphics and/or scientific (throughput) logic, or as special purpose cores); and 4) a system on a chip that may include on the same die the described CPU (sometimes referred to as the application core(s) or application processor(s)), the above described coprocessor, and additional functionality.

The input devices 206 and the output devices 208 provide means of communication between users and the MCU 202. Examples of the input devices 206 may include but are not limited to a keyboard, a mouse, a joystick, a keypad, a touch screen, soft keys, a floppy disk, a pen drive, a hard drive and the like. Examples of the output devices 208 may include, but are not limited to, a display such as a light emitting diode (LED) display, a thin-film transistor (TFT) display, a liquid crystal display, an active-matrix organic light-emitting diode (AMOLED) display, and the like.

The MCU 202 includes a RISC-V processer that is in compliance with RISC-V instruction set architecture (ISA).

An instruction set, or instruction set architecture (ISA), is the part of the computer architecture related to programming, and may include the native data types, instructions, register architecture, addressing modes, memory architecture, interrupt and exception handling, and external input and output (I/O). The term instruction generally refers to macro-instructions that is instructions that are provided to the processor (or instruction converter that translates (e.g., using static binary translation, dynamic binary translation including dynamic compilation), morphs, emulates, or otherwise converts an instruction to one or more other instructions to be processed by the processor) for execution as opposed to micro-instructions or micro-operations (micro-ops) that are the results of a processor's decoder decoding macro-instructions.

An instruction set includes one or more instruction formats. A given instruction format defines various fields (number of bits, location of bits) to specify, among other things, the operation to be performed (Opcode) and the operand(s) on which that operation is to be performed. Some instruction formats are further broken down though the definition of instruction templates (or sub formats). For example, the instruction templates of a given instruction format may be defined to have different subsets of the instruction format's fields (the included fields are typically in the same order, but at least some have different bit positions because there are less fields included) and/or defined to have a given field interpreted differently. Thus, each instruction of an ISA is expressed using a given instruction format (and, if defined, in a given one of the instruction templates of that instruction format) and includes fields for specifying the operation and the operands.

In general, the RISC-V instruction sets consist of four basic instruction sets and five extended instruction sets. The basic instruction sets include RV32I, RV32E, RV64I, and RV128I. The extended instruction sets include RV32IM, RVA, RVF, RVD, and RVC. In real-time applications, multiplication operations are important for many applications in the domain of digital signal processing, image processing, scientific computing and many more.

The MCU 202 implements RV32IM instruction sets to support RISC-V M-extension instructions on variable pipeline architecture. In other words, the MCU 202 is designed for implementing the RV32IM instruction sets, but the similar designs can be used for other instruction set implementation and enhancements. The MCU 202 is designed in such a way so that the power consumption can be reduced drastically.

In one embodiment, the MCU 202 is a pipeline RISC-V processor that includes various pipeline stages such as instruction fetch stage, instruction decoding stage, execution stage including one or more execution sub stages, and write-back stage.

In one embodiment, the MCU 202 includes an instruction fetching module 210, an instruction decoding module 212, an execution module 214 (further including a first execution unit 214a, a second execution unit 214b, and a clock gating circuit 214c), and a write back module 216. It should be noted that components, described herein, can be configured in a variety of ways, including electronic circuitries, digital arithmetic and logic blocks, and memory systems in combination with software, firmware, and embedded technologies. The different pipeline stages for implementing RV32IM instruction sets are implemented based on various modules included in the MCU 202.

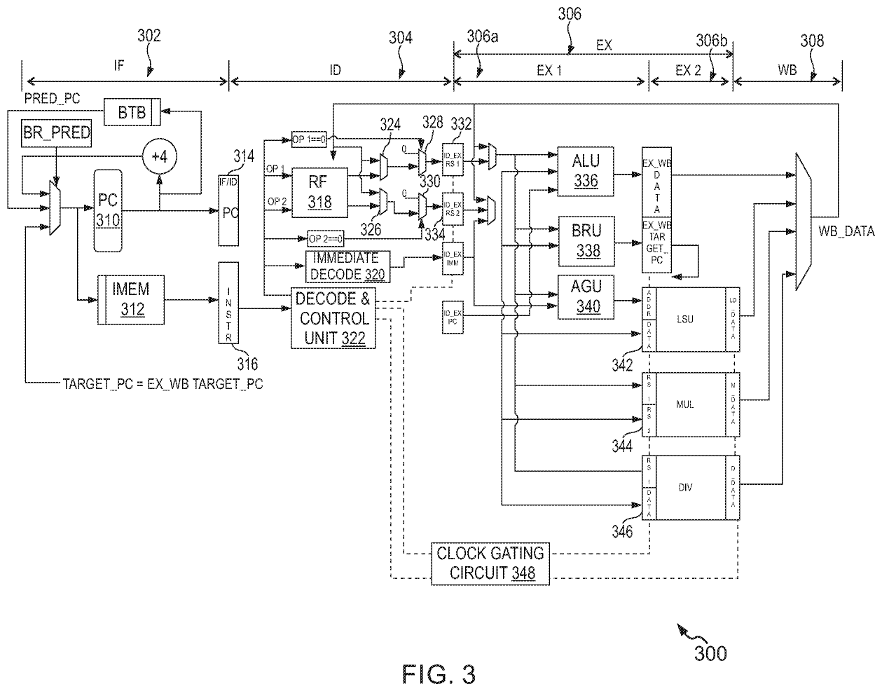

The instruction fetching (IF) module 210 includes suitable logic, circuitry, and/or interfaces to execute computer-readable instructions for fetching instructions from the memory 204. The memory 204 may include an instruction memory specifically used to store the instructions to be performed by the MCU 202. The IF module 210 is also configured to operate a program counter (PC) (not shown in the figure) based on the fetching operation. Different components of the IF module 210 are described in detail with respect to FIG. 3.

The instruction decoding (ID) module 212 includes suitable logic, circuitry, and/or interfaces to execute computer-readable instructions for decoding the instructions fed by the IF module 210 after fetching them from the memory 204. Generally, the ID module 212 decodes the instructions and operands to be fed to the functional units present in the execution module 214. The ID module 212 is configured to generate necessary control signals and decodes the operand address for register file (RF) (not shown in the figure), and immediate value fields. The ID module 212 also reads source operands from the RF. Different components of the ID module 212 are described in detail with respect to FIG. 3.

The execution module 214 includes suitable logic, circuitry, and/or interfaces to execute computer-readable instructions to execute a plurality of instruction sets. The plurality of instruction sets may include arithmetic instructions, load and/or store instructions, multiplication instructions, division instructions, and the like. The execution module 214 includes a first execution unit 214a (corresponding to the first execution stage ‘EX1’), a second execution unit 214b (corresponding to the second execution stage ‘EX2’), and a clock gating circuit 214c.

The execution module 214 is configured to initiate execution of an instruction to be fetched from the ID module 212. The execution module 214 may receive one or more micro-instructions, micro-code entry points, or other control signals, which reflect, or are derived from, the instructions. The execution module 214 is configured to execute the decoded instructions indicating one or more source operands and store a result in one or more destination operands of a register set indicated by the instructions. The execution module 214 may include circuitry or other execution logic (e.g., software combined with hardware and/or firmware) for executing the instructions or other control signals derived from the instructions and perform the instructions, accordingly.

In the first execution stage, the execution module 214 is configured to execute the instruction via a particular logic circuit from a plurality of first logic circuits associated with the first execution unit 214a. In other words, the instruction is executed in the first execution stage via one of the plurality of first logic circuits. During execution, the plurality of first logic circuits except the particular logic circuit is turned off using the clock gating circuit 214c.

In one embodiment, the second execution unit 214b is configured to execute instructions pertaining to a plurality of instruction types. The plurality of instruction types includes: (a) load and/or store instructions, (b) multiplication instructions, and (c) division instructions.

Thereafter, the execution module 214 determines or checks whether a type of the instruction is included in the plurality of instruction types or not. In response to a determination that the type of the instruction is not included in the plurality of instruction types, the execution module 214 disables a plurality of second logic circuits included in the second execution unit 214b by sending clock gating signals to the plurality of second logic circuits from the clock gating circuit 214c. In other words, the execution module 214 is configured to bypass the second execution unit 214b when there is no use of the second execution unit 214b and the clock gating is performed for the plurality of second logic circuits.

In one embodiment, in response to a determination that the type of instruction is included in the plurality of instruction types, the execution module 214 is configured to schedule and execute the instruction via the second execution unit 214b. In particular, the first execution unit 214a transmits operands associated with the instruction to the second execution unit. The clock gating circuit 214c is configured to activate a particular logic circuit from the plurality of second logic circuits based on the instruction type and disable the plurality of second logic circuits except the particular logic circuit and the plurality of first logic circuits of the first execution unit 214a.

In one example, when the multiplication instruction is being executed, the other logic circuits of the second execution unit are clock gated via the clock gating circuit 214c.

More illustratively, when the MCU 202 executes arithmetic or logical or branch instruction then execution flows as—IF, ID, EX1, WB, which is completely 4 stage. But when load/store instruction or multiplication or division instructions are executed then the first execution stage will pass the required operands for those operations to second execution stage. In those cases, the execution will be—IF, ID, EX1, EX2, WB; that is five stage. In most of the programs, Load/Store and Multiplication and division instructions are infrequent compared to arithmetic, logical and branch instructions. Moreover, the multiplication and division circuit is much larger in size compared to ALU and power consumption is also higher. This power and area factor is also true for the Load/Store unit (LSU). The execution module 214 is configured to bypass the EX2 stage when there is no use of this stage and clock gating is performed for the LSU, MUL and DIV unit. Furthermore, when any one of the units is utilized by the instruction execution then other units in the EX2 stage are also clock gated. For instance, if multiplication instruction is being executed, then LSU and DIV units are clock gated.

In one embodiment, the first execution stage ‘EX1’ takes one clock cycle to execute an instruction whereas the second execution stage ‘EX2’ may take one or more clock cycles for executing the instructions. The instruction sets are partitioned into the groups in a way that infrequent and higher computational resources are allocated into the second execution stage ‘EX2’, so the advantage of pipelining is applied to these units to maintain the higher operating frequency in VLSI and FPGA.

The write back module 216 includes suitable logic, circuitry, and/or interfaces to execute computer-readable instructions to write back the results of the first execution unit 214a and the second execution unit 214b to the register file (RF) (not shown in the figure).

The address bus 218 is configured to carry memory addresses from the MCU 202 to other components such as input/output devices. The address bus is unidirectional. The data bus 220 is configured to carry the data between the MCU 202 and other components. The data bus is bidirectional. The control bus 222 is configured to carry control signals from the MCU 202 to other components. The control bus also carries the clocks pulses. The control bus is unidirectional.

FIG. 3 is a schematic structural diagram 300 of an MCU, in accordance with an embodiment of the present disclosure. The MCU 202 is in compliant with the RISC-V instruction sets. The MCU 202 is of variable pipeline architecture in contrary to typical RISC-V processors. More illustratively, the MCU 202 implements the variable stage pipeline architecture for 4/5/6/7/8 stages. In other words, some instructions can be executed in 4 stage, some instructions can be executed in 5 stage and so on.

In one embodiment, the MCU 202 implements the following pipeline stages: instruction fetching (IF) stage (see, 302), instruction decoding (ID) stage (see, 304), execution (EX) stage (see, 306), and write-back (WB) stage (see, 308). The execution stage includes one or more execution stages such as, first execution stage (see, 306a, ‘EX1’), second execution stage (see, 306b, ‘EX2’), etc. The different pipeline stages are implemented based on various modules included in the MCU 202 as mentioned in the FIG. 2.

The instruction fetching (IF) module 210 corresponding to the IF stage 302 includes program counting (PC) generator (see, PC generator 310). The PC generator (see, 310) is configured to determine an address of to-be-fetched instruction.

The IF module 210 is configured to read an instruction from instruction memory (see, 312, ‘IMEM’) indexed by the PC generator 310. In other words, the PC generator 310 selects an instruction from the instruction memory. In one embodiment, the instruction may include a plurality of opcodes and operands. The PC generator 310 supports absolute and relative jump operations, and classic call/return operations as well. In particular, the PC generator 310 in operation holds an address that is itself a memory address or an address that points to a memory address from which the MCU fetches instructions.

In one example, the 32 bit instruction may be defined according to standard R-type instruction format. A format of the RV32I instruction is shown in the below table 1:

TABLE 1

| funct7 | rs2 | rs1 | funct3 | rd | opcode |
|---|---|---|---|---|---|
| [31:25] | [24:20] | [19:15] | [14:12] | [11:7] | [6:0] |

The PC generator 310 calculates the next program count value for instruction fetch from target PC value if jump or branch instruction is taken in execution stage, or from branch target buffer if the branch is predicted (br_pred) to be taken, otherwise, the sequential PC increments the current PC value by 4.

The IF module 210 is configured to deliver the fetched instruction to the ID module 212 (which corresponds to the ID stage 304). The ID module 212 includes an instruction register (IF/ID) 314, instruction address register 316, register file (RF) 318, an immediate decode 320, decode and control unit 322, four multiplexers (see, 324, 326, 328, 330).

The instruction address register 316 is connected to the decode and control unit 322 for generating necessary control signals, for example, determining ALU functions (e.g., addition or subtraction, etc.) and decoding register operand addresses for the register file and immediate value fields.

The register file (RF) 318 connected with the instruction register 314 is configured to store one or more opcodes in the RF 318. The RF 318 is configured to output the decoded target instruction to the first multiplexer 324 and the second multiplexer 326. A conditional control block (OP1==0) is connected to a selection control end of the third multiplexer 328. In similar manner, another conditional control block (OP2==0) is connected to a selection end of the fourth multiplexer 330. A first output end of the RF 318 is connected to an input end of the first multiplexer 324, and a second output end of the RF 318 is connected to an input end of the second multiplexer 326. Further, another input end of the first multiplexer 324 is connected with write-back stage output (i.e., WB_Data). In similar manner, another input end of the second multiplexer 326 is connected with the write-back stage output (i.e., WB_Data). Further, outputs of the first multiplexer 324 and the second multiplexer 326 are connected with the third multiplexer 328 and the fourth multiplexer 330, respectively.

An output end of the third multiplexer 328 is connected with first data register (see, ID_EX RS1, 332) of the first execution unit 214a of the execution module 214. An output end of the fourth multiplexer 330 is connected with second data register (see, ID_EX RS2, 334) of the first execution unit 214a.

The first execution unit 214a (corresponding to the EX1 stage 306a) includes a plurality of first logic circuits such as, arithmetic logic unit (ALU) 336 for performing arithmetic and logical instructions, a branch unit (BRU) 338 for branch instructions, and address generator unit (AGU) 340 for generating addresses for load and store operations. Thus, the first execution unit 214a handles arithmetic, logical, and branch instructions as well as calculations of load or store address. In one example, when the MCU 202 executes arithmetic, logical, or branch instruction, the execution flow is 4 stage pipeline instruction flow and includes IF stage, ID stage, EX1 stage, and WB stage.

The second execution unit 214b (corresponding to the EX2 stage 306b) includes a plurality of second logic circuits such as, load and store unit (see, LSU 342), multiplication unit (see, MUL 344), and a divider unit (see, DIV 346). In one example, when load/store operation, multiplication operation, or division instruction is executed, the first execution stage 306a transmits required operands for those operations to the second execution unit 214b. In these cases, the execution flow requires five-stage pipeline structure and includes IF, ID, EX1, EX2 and WB stages.

In one embodiment, the plurality of first logic circuits of the first execution unit and the plurality of second logic circuits are grouped in a way that a single logic circuit is activated during execution of the instruction at a time. Further, the plurality of first logic circuits is configured to perform simpler instructions than the the plurality of second logic circuits. Thus, the execution stage 206 is sub-divided into one or more stages based on various groups of instructions and their associated hardware complexities.

As mentioned earlier, the execution module 214 also includes a clock gating circuit 348 (similar to the clock gating circuit 214c). The clock gating circuit 348 is configured to clock gate or turn off branch circuits or logic circuits associated with a set of instructions that are not being executed. In other words, when any one of the logic circuits is utilized by the instruction execution then other logic circuits in the first execution stage ‘EX1’ and the second execution stage ‘EX2’ are turned off via the clock gating circuit 348. Thus, the clock gating circuit 348 significantly reduces dynamic power consumption. The clock gating circuit 348 may include clock gating cells, where each clock gating cell has one clock-enable signal. The clock gating circuit 348 is connected with the decode and control unit 322 of the ID module 212. The decode and control unit 322 may generate clock enable signals via the clock gating circuit 348 for the first execution stage ‘EX1’ and the second execution stage ‘EX2’ independently.

In one example, when the multiplication instruction is being executed, the LSU 342 and DIV 346 are clock gated via the clock gating circuit 348. The clock gating circuit may receive the clock gating enable signal for the MUL unit 344 from the decode and control unit 322 at the instruction decoding stage. In the FIG. 3, dotted lines from the clock gating circuit 348 represent clock gating signals for various logic circuits of the first execution unit 214a and the second execution unit 214b. Thus, the plurality of first logic circuits of the first execution unit 214a and the plurality of second logic circuits of the second execution unit 214b are grouped in a way that a single logic circuit is activated during execution of the instruction at a time.

Consequently, the MCU 202 can execute only one instruction in the execution stage in each clock cycle. As a result, the circuit required for execution of one instruction is different from another instruction. Among these instructions some instructions execution is simpler in terms of circuit such as arithmetic, logical, jump etc. and some requires relatively larger circuit such as multiplier and divider. To reduce the power of the processor, the execution module 214 is configured to clock gate the relevant circuits which are not being used the given instruction execution.

The write back module 216 is configured to write the outputs of first execution stage 306a and the second execution stage 306b to the RF 318.

Thus, this scheme can be extended in the same manner for variable stage pipeline architecture for 4/5/6/7/8 stage. In other words, in the proposed scheme, some instructions can be 4-stage, some can be 5-stage, and some can be 6-stage, and so on. For instance, implementation of RISC-V atomic extension might require 6-stage such that IF, ID, EX1, EX2, EX3, WB, where EX3 will perform the atomic add, subtraction etc.

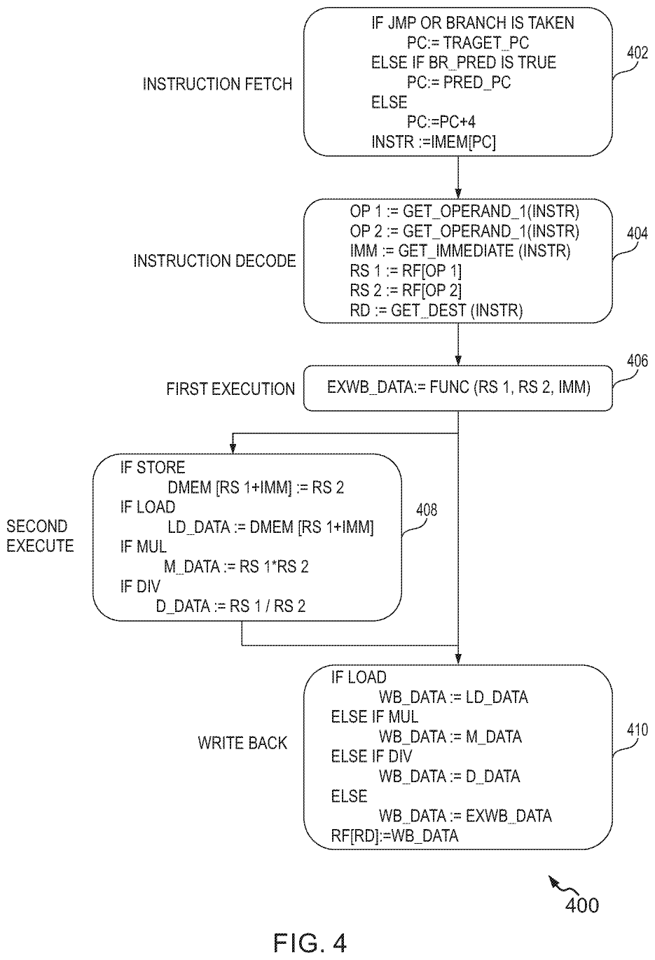

FIG. 4 is a flow chart 400 for an instruction execution flow of variable pipeline stage architecture, in accordance with an embodiment of the present disclosure. The instruction execution flow may include multiple pipeline stages.

In instruction fetch stage 402, an instruction is read from an instruction memory indexed by a program counter. The next value of PC is calculated for the instruction fetched from a target PC if a jump or a branch instruction is taken in execution stage. Alternatively, the next value of the PC is calculated from a branch target buffer (BTB) if the branch is predicted to be taken. Otherwise the current value of PC will be incremented by 4. The instruction from the instruction memory is transmitted to the instruction decode stage 404.

In the instruction decode stage 404, the instruction is decoded to generate the necessary control signals. The necessary control signals may be used to determine the function of AGU, BRU, ALU (e.g., addition or subtraction etc.), MUL, and/or DIV. The register operand address for register file and immediate value fields may also be decoded. The source operands may then be read from the register file.

In first execution stage 406, the decoded instruction is executed for performing operations such as, arithmetic operations, logical operations, branch instructions, and address generation of load and store operations, etc.

In one embodiment, the decoded instruction is checked to determine a type of the instruction. If the type of the instruction is associated with any one of the instructions such as, load and store instructions, division instructions, and multiplication instructions, the output of the first execution stage is transmitted to the second execution stage 408. Otherwise, the second execution stage 408 is bypassed by disabling a plurality of second logic circuits included in the second execution stage via a clock gating circuit and the output of the first execution stage 406 is directly passed to the next pipeline stage 410 (i.e., write back stage).

In one example, if the decoded instruction is RV32I type instruction, then, in next clock cycle, the output of the first execution stage is passed to the write back stage and the plurality of second logic circuits are disabled or turned off via the clock gating circuit. When the decoded instruction is RV32I type instruction, the decode and control unit (see, 322 shown in FIG. 3) associated the instruction decoding stage sends a signal to the clock gating circuit (see, 348 shown in FIG. 3) associated with the execution stage. Thereby, the clock gating circuit 348 immediately sends clock gating enable signals to the plurality of second logic circuits associated with the second execution stage to disable the plurality of second logic circuits.

In another example, if the decoded instruction is RV32IM type instruction, then, in next clock cycle, the output of the first execution stage 406 is passed to the second execution stage 408. Since the RV32IM instruction type represents multiplication operation, the plurality of second logic circuits except the multiplication unit and the plurality of first logic circuits associated with the first execution stage are turned off via the clock gating circuit. Referring back to FIG. 3, when the decoded instruction is RV32IM type instruction, the decode and control unit 322 associated the instruction decoding stage 304 sends a signal to the clock gating circuit 348 associated with the execution stage 306. Based on the signal, the clock gating circuit 348 immediately sends clock gating enable signals to the plurality of second logic circuits associated with the second execution stage 306b except the multiplication unit (see, MUL 344) and the plurality of first logic circuits associated with the first execution stage.

In the second execution stage 408, a set of instruction sets pertaining to a plurality of instruction types are executed. The plurality of instruction types may include: (a) load and/or store instructions, (b) multiplication instructions, and (c) division instructions. In one embodiment, the set of instruction sets utilizes multi-cycle functional units. For example, load instruction take two clock cycles.

In one embodiment, the second execution stage 408 includes the set of instruction sets that is infrequent and requires higher computational resources. In contrast, the first execution stage 406 performs those instructions that are frequent and require low computational resources. Moreover, the multiplication and divider circuit are much larger in size compared to ALU and power consumption is also higher. This power and area factor is also true for the Load/Store unit (LSU). Thus, bypassing the second execution stage when there is no use of this stage and clock gating is performed for the LSU, MUL and DIV units. The clock gating is used to turn off the branch or the set of instructions that is not being executed. This scheme significantly reduces the dynamic power consumption. For instance, if multiplication instruction is being executed then EX1 stage, LSU and DIV unit is clock gated and the decode and control unit generates the clock gating enable signal at the instruction decoding stage.

At 410, during the write back stage, outputs obtained from the first execution stage and/or the second execution stage are written back to the register file (see, 318 in FIG. 3).

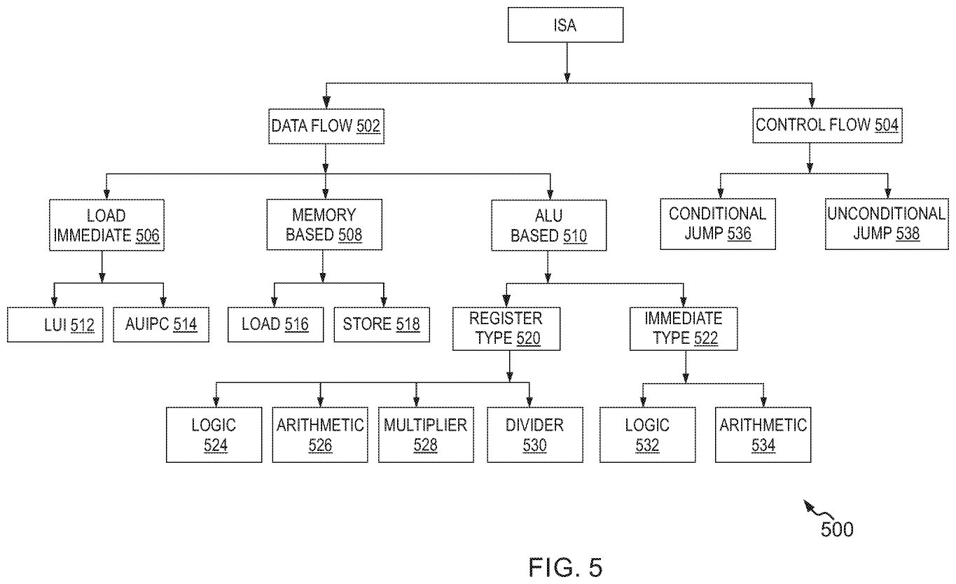

FIG. 5 is a schematic graphical representation 500 of RISC-V instruction sets, in accordance with an embodiment of the present disclosure.

To optimize RISC-V micro architecture of the MCU 202, an equivalent graph or tree representation of RISC-V instruction sets (ISA) is generated. In the graph representation, each leaf node indicates similar type of instructions from RISC-V instruction sets. The MCU 202 is configured to implement a graph model (as shown in the FIG. 5) to create groups of RV32IM instruction sets for maximum sharing of logic gates. In other words, the MCU 202 is configured to divide execution of the RV32IM instruction sets in different pipeline stages based on the created groups of RV32IM instruction sets. In particular, the MCU 202 is configured to divide the execution stage into two or more pipeline stages based on the created groups of RV32IM instructions.

As shown in the FIG. 5, there are two types of instructions in the tree representation of the RISC-V instruction sets: (1) ‘Data Flow’ (see, 502), and (2) ‘Control Flow’ (see, 504). There is no common functionality between the two types of instructions. In similar manner, the ‘Data Flow’ instructions (see, 502) can further be divided into three sub-nodes such as, (1) ‘Load Immediate’ (see, 506), (2) ‘Memory Based’ (see, 508), and (3) ‘ALU based’ (see, 510). The common logic between the three sub-nodes is shared at the ‘Data Flow’ level of the instruction execution. For example, ‘load’ and ‘store’ address generator and ALU based instructions utilize same adder logic as part of the execution. In other words, the adder logic is the same for all these ‘Data Flow’ sub-nodes of instructions. The similar logic is applied for all sub-nodes of instructions, thereby optimizing the use of common logic to reduce the total logic of the microprocessor core and hence reduce the power consumption.

The ‘Load Immediate’ (see, 506) can further be divided into LUI (load upper immediate) (see, 512) and AUIPC (Add upper immediate to PC) (see, 514). The ‘Memory Based’ instruction (see, 508) may further be divided into load (see, 516) and store (see, 518). The ‘ALU based’ instruction can be divided into register type 520 (further divided into ‘Logic’ 524, arithmetic 526, multiplier 528, divider 530) and immediate type 522 (further divided into ‘Logic’ 532 and arithmetic 534). The ‘Control Flow’ instruction (see, 504) is divided into two types: conditional jump 536 and unconditional jump 538.

Thus, instruction sets are divided into two (or may be into more groups) such that one group will contain most frequently used instructions and whose functional units are smaller in size for implementation, and rest of the instructions will be there in other group of execution stage. Based on the division of the instruction sets, the execution stage is divided into two or more execution stages. The graph based algorithm is used to group the RV32IM instruction set for maximum sharing of logic gates resulting in smallest sized design for RISC-V based microcontroller.

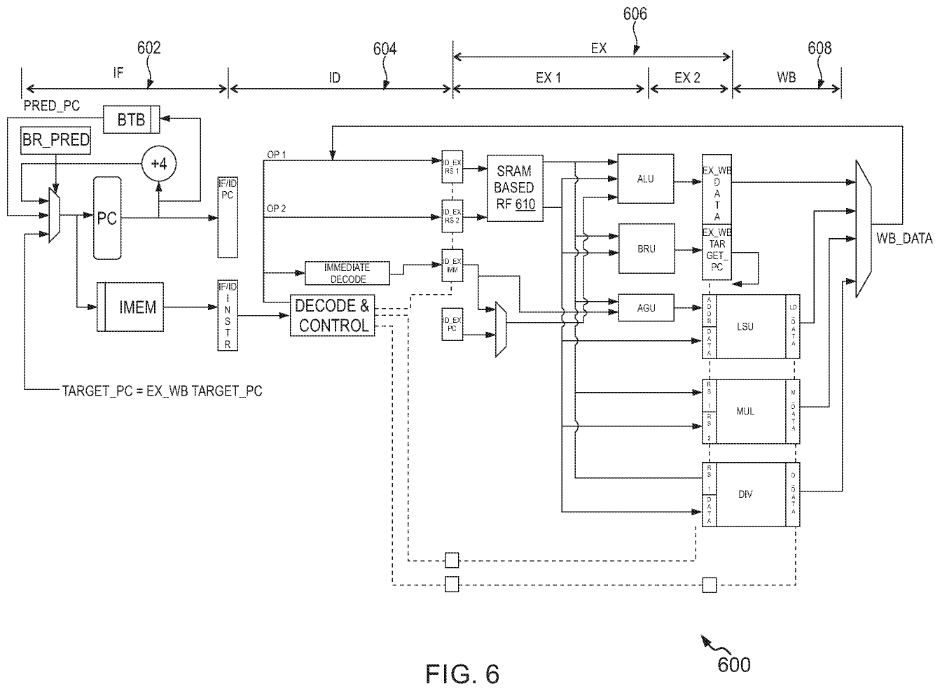

FIG. 6 is a schematic structural diagram of an MCU 600 with static random-access memory (SRAM) based register file (RF), in accordance with an embodiment of the present disclosure. The MCU 600 is in compliant with the RISC-V instruction sets. The MCU 600 is of variable pipeline architecture in contrary to typical RISC-V processors. More illustratively, the MCU 600 implements the variable stage pipeline architecture for 4/5/6/7/8 stages. In other words, some instructions can be executed in 4 stage, some instructions can be executed in 5 stage and so on.

In one embodiment, the MCU 600 implements the following pipeline stages: instruction fetching (IF) stage, instruction decoding (ID) stage, execution (EX) stage, write-back (WB) stage. The execution stage includes one or more execution stages such as, first execution stage ‘EX1’, second execution stage ‘EX2’, etc. The different pipeline stages are implemented based on various modules included in the MCU 600 as described in the MCU 202 in the FIG. 2.

In one embodiment, the MCU 600 includes an instruction fetching (IF) module 602, an instruction decoding module 604, an execution module 606, and a write back module 608.

The MCU 600 has similar architecture as described in the FIG. 3 except that the register file present in the instruction decoding module 604 is an SRAM based RF 610. Usually, the register file (containing 32 registers) is implemented as flip-flop array. On the other hand, the SRAM based RF 610 contains a row and column decoder coupled transistor-based SRAM cell that enables reducing the logic size. The SRAM based RF 610 is directly connected to a first execution unit of the execution module 606. The SRAM based RF 610 inherently contains the row and column decoder for read and write operation. The SRAM based RF 610 is used to directly feed the RF read operation output to ALU, AGU and BRU as depicted in FIG. 6. This eliminates need of extra registers to the RF read output data.

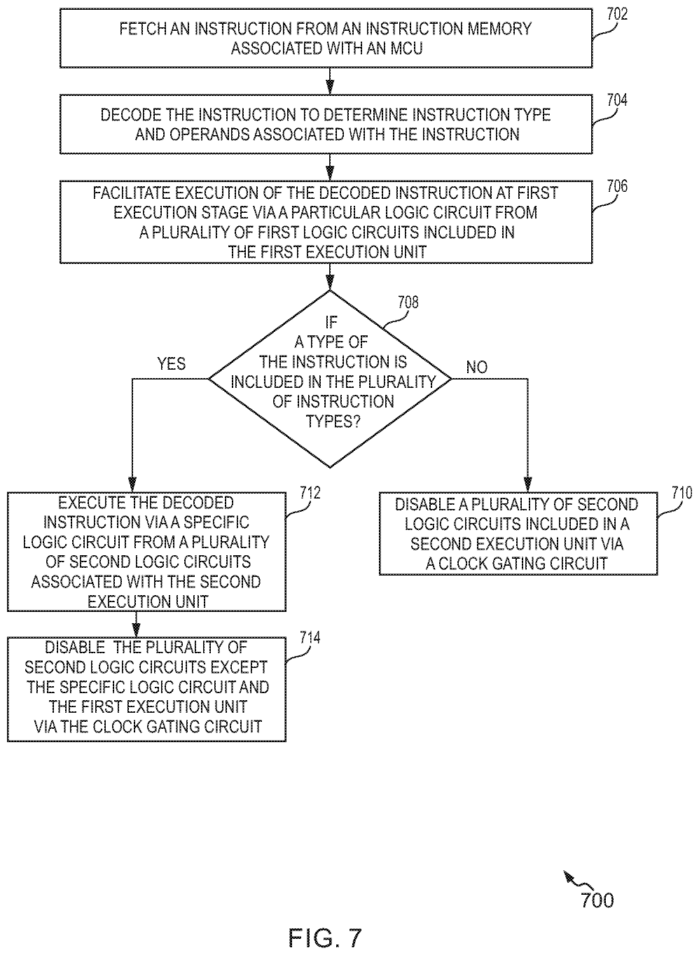

FIG. 7 is a flow chart 700 for a process flow (i.e., a computer-implemented method) for metering power consumptions of an MCU, in accordance with an embodiment of the present disclosure. The process depicted in the flow chart 700 may be executed by, for example, an MCU such as the MCU 202 as described in FIG. 2. Operations of the flow chart 700, and combinations of operation in the flow chart 700, may be implemented by, for example, hardware, firmware, a processor, circuitry, and/or a different device associated with the execution of software that includes one or more computer program instructions.

As mentioned earlier, the MCU 202 is based on RISC-V instruction set architecture and implements RV32I instructions with M-extensions. The process flow facilitates reduction of power consumption by clock gating one or more logic circuits while executing an instruction.

At 702, the MCU 202 fetches an instruction from an instruction memory associated with the MCU 202.

At 704, the MCU 202 decodes the instruction to determine instruction type (for example, arithmetic operations, multiplication, etc.) and operands associated with the instruction. The MCU 202 also generates necessary control signals based on the decoded instruction. The decoded instruction may include operands and control signals to be fed to a functional unit present in the next pipeline stage.

At 706, the MCU 202 facilitates execution of the decoded instruction at first execution stage via a particular logic circuit (determined based on the instruction type) from a plurality of first logic circuits included in a first execution unit 214a. The plurality of first logic circuits is implemented at the first execution stage. While executing the decoded instruction via the particular logic circuit, the MCU 202 also facilitates turning off the plurality of first logic circuits except the particular logic circuit via the clock gating circuit.

At 708, the MCU 202 checks or determines if a type of the instruction is included in a plurality of instruction types or not. The plurality of instructions types are those instructions that are only executed by the second execution unit.

If it is determined that the type of the instruction is not included in the plurality of instruction types, at 710, the MCU 202 disables a plurality of second logic circuits included in the second execution unit 214b via the clock gating circuit 214c.

If it is determined that the type of the instruction is included in the plurality of instruction types, at 712, the MCU 202 executes the decoded instruction via a specific logic circuit from a plurality of second logic circuits associated with the second execution unit. The specific logic circuit from the plurality of second logic circuits is activated using the clock gating circuit based on the type of the instruction.

At 714, the plurality of second logic circuits except the specific logic circuit and the first execution unit are disabled during the execution via the clock gating circuit.

FIGS. 8A and 8B, collectively, represent block diagram representations of an interface bus of an MCU with RISC-V architecture, in accordance with an embodiment of the present disclosure.

FIG. 8A shows different components of the interface bus 800. The MCU may be provided with a full implementation of microprocessor core 802 (e.g., AR32Z on-chip bus) and AXI/AHB bus matrix. The microprocessor core 802 has instruction bus (IBUS) and data bus (DBUS) for instruction memory interface and data memory interface, respectively. In other words, the microprocessor core 802 may retrieve data from an information bus (IBUS) router 804 and a data bus (DBUS) router 806 via information bus (IBUS) 808 and data bus (DBUS) 810, respectively.

The AR32Z on-bus chip is a scalar micro architecture. The AR32Z on-bus chip finds its applications in sensors interface, energy harvesting, battery operated embedded IoT, and medical applications.

The IBUS router 804 and the DBUS router 806 may be connected to the AXI/AHB bus matrix 812 via AXI/AHB bus 814a and 814b, respectively. Further, the IBUS router 804 is connected to an Information cache (ICACHE) 816, and the DBUS router 806 is connected to a data cache (DCACHE) 818. The DBUS router 806 is also connected to an accelerator/co-processor 820 and a tightly-coupled data memory (TCDM) 822. Furthermore, a tightly-coupled information memory (TCIM) 824 is connected to both IBUS router 804 and the DBUS router 806.

Referring now to FIG. 8B, a signal interface 840 between master and slave is shown, in accordance with an embodiment of the present disclosure. The core interface channel includes address channel 842 and read data channel 844. The address channel 842 and the read data channel 844 maybe established between a master (for example, RISC processor) 846 and a slave 848 (for example, memory, RF, output devices, and/or other co-processors).

Each channel performs their transactions independently. The address channel 842 provides addresses for read or writes transaction to the slave 848. If the master 846 requests the write transaction, the address channel 842 provides the write data to the slave 848. During read transaction, the master 846 transfers the read address through the address channel 842 and later receives the data from read data channel 844.

The valid signals (such as, Avalid, Rvalid) propagate forward to indicate that new data is available for the next stage. And the stall signals (such as, Astall, Rstall) propagate backward to signal the previous stage to halt.

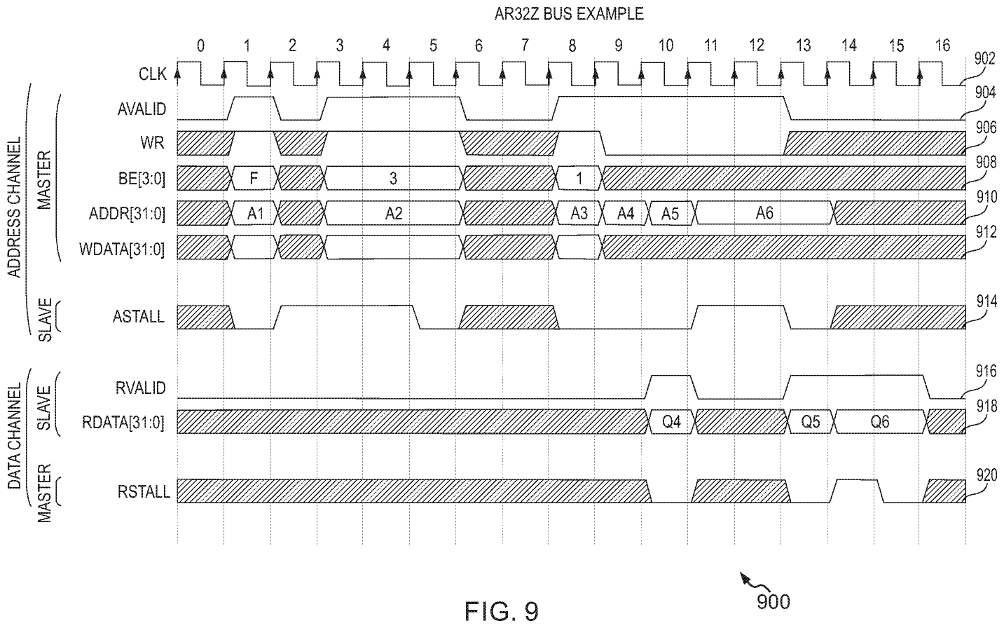

FIG. 9 is a timing diagram 900 representing the read and write transaction on the interface bus, in accordance with an embodiment of the present disclosure. Referring back to FIG. 8, the microprocessor core 802 has an instruction bus (IBUS) 808 and data bus (DBUS) 810 for instruction memory interface and data memory interface, respectively.

In one embodiment, interface bus protocols such as, IBUS 808 and DBUS 810 are specified in such a way that there is no power consumption when read and write data are in ‘don't care’ state. In general, ‘don't care’ state refers to input sequence of a function for which the function output does not matter.

More illustratively, the interface bus protocols such as IBUS 808 and DBUS 810 are designed in a way that renders maximum optimization for power consumption reduction in computing devices (for example, IoT devices). In general, processors do not perform memory read and write operations in every clock cycle.

When a read or write transaction is initiated, associated address and data signals are sampled by the interface bus and AXI/AHB bus matrix, otherwise, IBUS 808 and DBUS 810 bus signals are in don't care state (i.e., the BUS signals are clock gated to reduce the power).

As shown in the FIG. 9, a clock signal is denoted by clk 902. In one embodiment, the time to sample the BUS signals are indicated by control signals such as, Avalid 904, Astall 914, Rvalid 916 and Rstall 920. During the write operation, the control signals may further include Wr signal 906 and be[3:0] signal 908.

The valid signals (such as, Avalid, Rvalid) propagate forward (from master to slave) to indicate that new data is available for the next stage. And the stall signals (such as, Astall, Rstall) propagate backward (from slave to master) to signal the previous stage to halt.

In one example, when the Avalid signal 904 is high, and Astall signal 914 is low, address channel (see, Addr 910) and data over the write data channel (see, Wdata 912) is sampled for write operation. In another example, when the Rvalid 916 is high and Rstall 920 is low, data over the read data channel (see, Rdata 918) is sampled for read operation. Thus, the above approach maximizes power saving during memory data transactions.

Various embodiments of the present disclosure offer multiple advantages and technical effects. For instance, the present disclosure utilizes variable pipeline stage architecture based RISC-V micro-controller units. The present disclosure renders smallest size RISC-V process for RV32IM. As a result, the power consumption is an order of magnitude less than any other processor cores. The present disclosure also describes a method for metering or reducing power consumption for an MCU. The motivation of variable pipeline architecture is to break down the instruction sets into two (or may be into more groups) such that one group will contain most frequently used instructions and whose functional units are smaller in size for implementation, and rest of the instructions in other group of execution stage. Now the execution stage will be subdivided into two (or more) stages. This results the variable pipeline execution. And different functional units of this execution stages will be clock gated based on the instruction execution.

Although the present technology has been described with reference to specific exemplary embodiments, it is noted that various modifications and changes may be made to these embodiments without departing from the broad spirit and scope of the present technology. For example, the various systems, modules, etc., described herein may be enabled and operated using hardware circuitry (e.g., complementary metal oxide semiconductor (CMOS) based logic circuitry), firmware, software and/or any combination of hardware, firmware, and/or software (e.g., embodied in a machine readable medium). For example, the various modules and methods may be embodied using transistors, logic gates, and electrical circuits (e.g., application specific integrated circuit (ASIC) circuitry and/or in Digital Signal Processor (DSP) circuitry).

Also, techniques, subsystems and methods described and illustrated in the various embodiments as discrete or separate may be combined or integrated with other systems, modules, techniques, or methods without departing from the scope of the present technology. Other items shown or discussed as directly coupled or connected with one another, or as directly communicating with each other, may be communicatively associated through some interface or device, such that the items may no longer be considered directly coupled or connected with one another, or directly communicating with each other, but may still be indirectly communicatively associated and in communication, whether electrically, mechanically, or otherwise, with one another. Other examples of changes, substitutions, and alterations ascertainable by one skilled in the art, upon studying the exemplary embodiments disclosed herein, may be made without departing from the spirit and scope of the present technology.

It should be noted that reference throughout this specification to features, advantages, or similar language does not imply that all of the features and advantages should be or are in any single embodiment. Rather, language referring to the features and advantages may be understood to mean that a specific feature, advantage, or characteristic described in connection with an embodiment may be included in at least one embodiment of the present technology. Thus, discussions of the features and advantages, and similar language, throughout this specification may, but do not necessarily, refer to the same embodiment. Various embodiments of the present invention, as discussed above, may be practiced with steps and/or operations in a different order, and/or with hardware elements in configurations which are different than those which are disclosed. Therefore, although the technology has been described based upon these exemplary embodiments, it is noted that certain modifications, variations, and alternative constructions may be apparent and well within the spirit and scope of the technology.

Although various exemplary embodiments of the present technology are described herein in a language specific to structural features and/or methodological acts, the subject matter defined in the appended claims is not necessarily limited to the specific features or acts described above. Rather, the specific features and acts described above are disclosed as exemplary forms of implementing the claims.

The foregoing detailed description of the invention has been presented for purposes of illustration and description. It is not intended to be exhaustive or to limit the invention to the precise form disclosed. Many modifications and variations are possible in light of the above teaching. The described embodiments were chosen to best explain the principles of the invention and its practical application, to thereby enable others skilled in the art to best utilize the invention in various embodiments and with various modifications as are suited to the particular use contemplated. It is intended that the scope of the invention be defined by the claims appended hereto.

What is claimed is:

1. A micro-controller unit (MCU), comprising:
an instruction fetching (IF) module configured to fetch an instruction from an instruction memory;
an instruction decoding (ID) module configured to decode the instruction to obtain decoded instruction; and
an execution module comprising a first execution unit, a second execution unit and a clock gating circuit, the second execution unit configured to execute a plurality of instruction types, the execution module configured to:
receive the decoded instruction for executing from the instruction decoding module,
execute the decoded instruction via a particular logic circuit from a plurality of first logic circuits associated with the first execution unit, wherein the plurality of first logic circuits except the particular logic circuit is turned off during the execution via the clock gating circuit,
determine whether a type of the decoded instruction is included in the plurality of instruction types or not, and
in response to a determination that the type of the decoded instruction is not included in the plurality of instruction types, disable a plurality of second logic circuits included in the second execution unit via the clock gating circuit.

2. The MCU as claimed in claim 1, wherein the MCU is in compliance with RISC-V instruction sets, and wherein the MCU is of variable pipeline structure.

3. The MCU as claimed in claim 1, wherein the plurality of instruction types associated with the second execution unit comprises: (a) load and/or store instructions, (b) multiplication instructions, and (c) division instructions.

4. The MCU as claimed in claim 1, further comprising a write back module.

5. The MCU as claimed in claim 1, wherein the execution module is further configured to execute the instruction via the second execution unit by:
in response to a determination that the instruction is included in the plurality of instruction types, transmitting, by the first execution unit, operands associated with the instruction to the second execution unit,
activating a specific logic circuit from the plurality of second logic circuits via the clock gating circuit based on the type of the instruction, and
disabling the plurality of second logic circuits except the specific logic circuit of the plurality of second logic circuits and the plurality of first logic circuits of the first execution unit via the clock gating circuit.

6. The MCU as claimed in claim 1, wherein the MCU is configured to implement a graph model to group RV32IM instruction sets for maximum sharing of logic gates.

7. The MCU as claimed in claim 1, wherein the plurality of first logic circuits of the first execution unit comprises arithmetic logic unit (ALU), branch unit (BRU), and address generator unit (AGU), and wherein the plurality of second logic circuits of the second execution unit comprises multiplication unit, load and store unit (LSU), and divider unit.

8. The MCU as claimed in claim 1, wherein the plurality of first logic circuits of the first execution unit and the plurality of second logic circuits of the second execution unit are grouped in a way that a single logic circuit is activated during the execution of the instruction at a time.

9. A computer-implemented method, comprising:
fetching, by an instruction fetching (IF) module of a micro-controller unit (MCU), an instruction from an instruction memory;
decoding, by an instruction decoding (ID) module of the MCU, the instruction to obtain decoded instruction;
receiving, by an execution module of the MCU, the decoded instruction for executing from the instruction decoding module, the execution module comprising a first execution unit, a second execution unit and a clock gating circuit, and the second execution unit configured to execute a plurality of instruction types;
executing, by the first execution unit, the decoded instruction via a particular logic circuit from a plurality of first logic circuits associated with the first execution unit, wherein the plurality of first logic circuits except the particular logic circuit is turned off during the execution via the clock gating circuit;
determining, by the execution module, whether a type of the decoded instruction is included in the plurality of instruction types or not; and
in response to determining that the type of the decoded instruction is not included in the plurality of instruction types, disabling, by the execution module, a plurality of second logic circuits included in the second execution unit via the clock gating circuit.

10. The computer-implemented method as claimed in claim 9, wherein the MCU is in compliance with RISC-V instruction sets, and wherein the MCU is of variable pipeline structure.

11. The computer-implemented method as claimed in claim 9, wherein the plurality of instruction types associated with the second execution unit comprises: (a) load and/or store instructions, (b) multiplication instructions, and (c) division instructions.

12. The computer-implemented method as claimed in claim 9, further comprising in response to determining that the instruction is included in the plurality of instruction types:
transmitting, by the first execution unit, operands associated with the instruction to the second execution unit;
activating a specific logic circuit from the plurality of second logic circuits via the clock gating circuit based on the type of the instruction; and
disabling the plurality of second logic circuits except the specific logic circuit of the plurality of second logic circuits and the plurality of first logic circuits of the first execution unit via the clock gating circuit.

13. The computer-implemented method as claimed in claim 9, wherein the plurality of first logic circuits of the first execution unit and the plurality of second logic circuits of the second execution unit are grouped in a way that a single logic circuit is activated during execution of the instruction at a time.

14. The computer-implemented method as claimed in claim 9, wherein the plurality of first logic circuits of the first execution unit comprises arithmetic logic unit (ALU), branch unit (BRU), and address generator unit (AGU), and wherein the plurality of second logic circuits of the second execution unit comprises multiplication unit, load and store unit (LSU), and divider unit.

15. A micro-controller unit (MCU) with variable pipeline structure compliance with RISC-V based architecture, the MCU configured to:
fetch an instruction from an instruction memory;
decode the instruction to obtain decoded instruction;
facilitate execution of the decoded instruction via a particular logic circuit from a plurality of first logic circuits included in a first execution unit, wherein the plurality of first logic circuits except the particular logic circuit is turned off during the execution via a clock gating circuit;
determine whether a type of the instruction is included in a plurality of instruction types or not, the plurality of instruction types executed by a second execution unit;
in response to a determination that the type of the decoded instruction is not included in the plurality of instruction types, disable a plurality of second logic circuits included in the second execution unit via the clock gating circuit; and
in response to a determination that the type of the decoded instruction is included in the plurality of instruction types, execute the decoded instruction via a specific logic circuit from a plurality of second logic circuits associated with the second execution unit, wherein the plurality of second logic circuits except the specific logic circuit from the plurality of second logic circuits and the first execution unit are turned off during the execution via the clock gating circuit.

16. The MCU as claimed in claim 15, wherein the MCU is further configured to implement a graph model to group RV32IM instruction sets for maximum sharing of logic gates.

17. The MCU as claimed in claim 15, wherein the MCU comprises an instruction fetching (IF) module, an instruction decoding (ID) module, an execution module, and a write back module, and wherein the execution module comprises the first execution unit, the second execution unit, and the clock gating circuit.

18. The MCU as claimed in claim 15, wherein the plurality of first logic circuits of the first execution unit and the plurality of second logic circuits of the second execution unit are grouped in a way that a single logic circuit is activated during execution of the instruction at a time.

19. The MCU as claimed in claim 15, wherein the plurality of instruction types associated with the second execution unit comprises: (a) load and/or store instructions, (b) multiplication instructions, and (c) division instructions.

20. The MCU as claimed in claim 15, wherein the plurality of first logic circuits of the first execution unit and the plurality of second logic circuits of the second execution unit are grouped in a way that a single logic circuit is activated during execution of the instruction at a time.
